(19) United States
(12) Patent Application Publication
(10) Pub. No.: US 2016/0092397 A1
(43) Pub. Date: Mar. 31, 2016

(54) ANALOG CO-PROCESSOR

(71) Applicant: Zentrum Mikroelektronik Dresden AG, Dresden (DE)

(72) Inventor: Carroll Conklin, Bradford, MA (US)

(21) Appl. No.: 14/502,432

(22) Filed: Sep. 30, 2014

(51) Int. Cl. G06F 15/80

(52) U.S. Cl. CPC G06F 15/80

(57) ABSTRACT

An analog co-processor for a mixed signal processing system. The analog co-processor includes a plurality of components that cannot be manufactured in a sub-micron fabrication process. Each of the plurality of components is configured to perform analog or mixed signal processing. The plurality of components may be arranged on a single substrate.

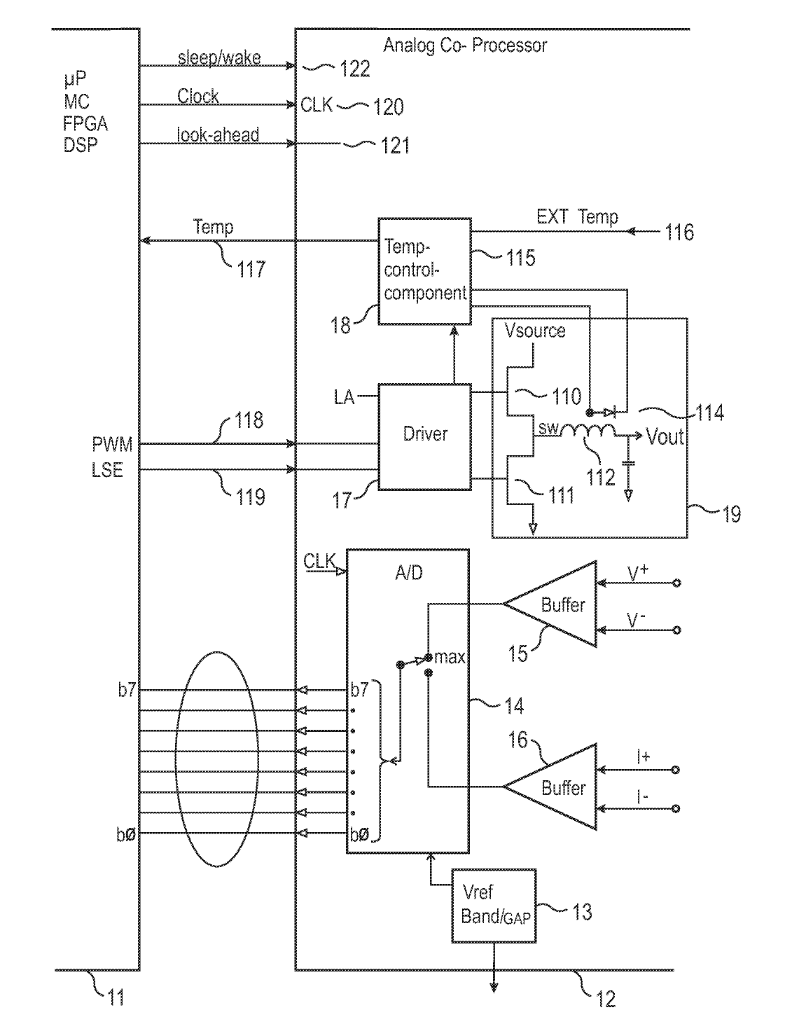

### FIELD OF THE INVENTION

The present invention relates to an analog co-processor. The present invention specifically relates to an analog co-processor for power converters.

### BACKGROUND OF THE INVENTION

The concept of a co-processor has so far been established with respect to digital signal processing wherein a mathematical digital co-processor is provided with instructions from a digital co-processor in order to execute a specific type of computationally expensive code faster than the digital processor can do. Hence, the digital co-processor supports the digital processor. The digital co-processor is designed for a reduced instruction set compared to the digital processor that allows the digital co-processor to process the reduced instruction set at a much higher speed and in parallel to the code execution of the digital processor.

However, the concept of co-processing has so far been established only with respect to pure digital signal processing. No solutions for mixed signal processing exist so far.

### DISCLOSURE OF THE INVENTION

It is an objective of the present invention to provide co-processing to a digital integrated circuit in a mixed signal environment.

This objective is achieved with a solution according to the independent claim. Dependent claims relate to further aspects of the present invention.

The present invention relates to an analog co-processor for a mixed signal processing system. The analog co-processor comprises a plurality of components that cannot be manufactured in a sub-micron fabrication process. Each of the plurality of components configured to perform analog or mixed signal processing. The plurality of components may be arranged at a single substrate.

Specifically, the analog co-processor can be configured to perform analog processing according to control instructions received from a digital integrated circuit that can be manufactured in a sub-micron process. Thus, the analog co-processor and the digital integrated circuit form a mixed signal processing system, wherein any analog processing of components that cannot be manufactured in a sub-micron process is bundled in the analog co-processor, while the pure digital signal processing is bundled in the digital integrated circuit that in contrast to the analog co-processor can be manufactured in a sub-micron processes.

The analog co-processor can be configured to convert any analog processing results it produced into the digital domain and to provide digitized analog processing results to the digital integrated circuit that can be manufactured in a sub-micron process. Specifically, the analog co-processor may comprise a flash analog to digital converter employing low current successive approximation with look-ahead for digitizing the analog processing results.

Specifically, the analog co-processor may be configured to perform analog co-processing for power conversion. Thus, the analog co-processor provides a tightly coupled and highly integrated interim solution to facilitate the migration of power conversion into the co-processor. The co-processor may be a field programmable gate array (FPGA) package.

An analog co-processor employed for power conversion may comprise any analog component of a power stage of a power converter such as output capacitors, output chokes, band-gap reference, error amplifier or power switches such as power metal oxide semiconductor field effect transistors for high current rails. Moreover, the analog co-processor may comprise components used for mixed signal processing such as analog to digital or digital to analog converters or driver circuits for the power stage of the power converter. The analog co-processor may further comprise auxiliary power rails for disk drives, displays, etc..

Moreover, the analog co-processor may be configured to perform hand-shaking functions with the digital integrated circuit such as a look-ahead function for a state change, LSE operation, discontinuous conduction mode (DCM) operation, standby/sleep function or watch-dog function such as temperature or excess current surveillance.

Furthermore, a sub-set of the plurality of components may be stacked in a three-dimensional stack. A three dimensional stack is advantageous in terms of heat migration. Specifically, if heat generating filter capacitors or output chokes of a power stage of a power converter are stacked, the stack will have a chimney effect transporting the heat vertically up the stack. The three dimensional stack reduces the printed circuit board (PCB) footprint and maintains tight coupling.

As the analog co-processor is physically separated from the digital integrated circuit, leakage currents produced by analog or mixed signal components cannot contaminate the digital domain.

### BRIEF DESCRIPTION OF THE DRAWINGS

The present invention will be explained in more detail by way of an exemplary embodiment in connection with a drawing in which the FIGURE shows a mixed signal processing system comprising an analog co-processor.

### DETAILED DESCRIPTION OF THE INVENTION

The FIGURE shows a mixed signal processing comprising a digital integrated circuit 11 and an analog co-processor 12. The analog processor comprises a driver 17 for a power stage 19 of a buck converter. The power stage comprises a pair of power MOSFETs 110, 111, an inductor (choke) 112 and a capacitor at which the power stage 19 generates an output voltage Vout according to a pulse width modulation (PWM) switching signal 118 received from the digital integrated circuit 11. The PWM switching signal 118 is generated according to a control law implemented in the digital integrated circuit 11. The control processes an error voltage, i.e. a difference between the output voltage and a reference voltage. The reference voltage Vref 13 is generated as a band gap reference which is digitized by means of an analog to digital converter 14. The output voltage Vout is also digitized by the analog to digital converter 14. The output voltage Vout is a differential output voltage V+ and V− and buffered by buffer 15 prior to digitization. The control law may process as well an output current, which may be a differential current I+ and I−. The differential current I+ and I− is buffered in buffer 16 prior to digitization. It can be observed that the analog co-processor implements a plurality of hand-shaking functions with the digital integrated circuit such as a look-ahead function for a state change 121, LSE operation 119, sleep/wake function 122 and watch-dog function such as temperature 117 or excess current surveillance. For temperature surveillance the analog co-processor comprises a temperature control component 115 that processes an external temperature 116 as well as an overcurrent measured by diode 114. The temperature control component 115 is driven by driver 18 and provides a temperature indication 117 to the digital integrated circuit 11. The analog co-processor receives a clock signal 120 for clocking clocked components like the analog to digital converter 14 from the digital integrated circuit 11. The digital integrated circuit 11 may bring the analog co-processor into operation by means of a wake signal and may shut it off or bring it into stand-by by means of a sleep signal.

1. Analog co-processor for a mixed signal processing system, the analog co-processor comprising a plurality of components that cannot be manufactured in a sub-micron fabrication process, each of the plurality of components configured to perform analog or mixed-signal processing.

2. The analog co-processor according to claim 1 configured to perform analog processing according to control instructions received from a digital integrated circuit that can be manufactured in a sub-micron process.

3. The analog co-processor according to claim 2 configured to convert analog processing results into a digital domain and to provide digitized analog processing results to the digital integrated circuit that can be manufactured in a sub-micron process.

4. The analog co-processor according to claim 1, wherein a component of the plurality of components is a band-gap reference for a power stage of a switched power converter.

5. The analog co-processor according to claim 1, wherein a component of the plurality of components is an error amplifier for a control circuit.

6. The analog co-processor according to claim 1, wherein a component of the plurality of components is a pair of power switches for a power stage of a switched power converter.

7. The analog co-processor according to claim 1, wherein a component of the plurality of components is an output choke for a power stage of a switched power converter.

8. The analog co-processor according to claim 1, wherein a component of the plurality of components is a driver circuit for a power stage of a power converter.

9. The analog co-processor according to claim 2, configured to perform a hand-shaking function with the digital integrated circuit that can be manufactured in a sub-micron fabrication process.

10. The analog co-processor according to claim 9, wherein the hand-shaking function comprises any of look-ahead function for state change, LSE operation, DCM operation, standby/sleep function, watch-dog function.

11. The analog co-processor according to claim 1, wherein a sub-set of the plurality of components is stacked in a three dimensional stack.

12. The analog co-processor according to claim 11, wherein the sub-set of the plurality of components comprises an output choke and a filter capacitor of a power stage of a power converter.

13. The analog co-processor according to claim 2, nested into the digital integrated circuit that can be manufactured in a sub-micron process.

14. The analog co-processor according to claim 2, wherein the analog co-processor is vertically stacked upon the digital integrated circuit that can be manufactured in a sub-micron process.

15. The analog co-processor according to claim 1 individually packed.
